(19) United States
(12) Patent Application Publication
(10) Pub. No.: US 2026/0119959 A1
(43) Pub. Date: Apr. 30, 2026

(54) SOFTWARE-DEFINED MOCK QPU TOPOLOGY

(71) Applicant: Dell Products L.P., Round Rock, TX (US)

(72) Inventors: Brendan Burns Healy, Haddonfield, NJ (US); Robert Lee, Marlborough, MA (US)

(21) Appl. No.: 18/884,561

(22) Filed: Sep. 13, 2024

(51) Int. Cl. G06N 10/80

(52) U.S. Cl. CPC G06N 10/80

(57) ABSTRACT

One example method includes receiving, from a user, a QPU (quantum processing unit) topology configuration in raw form, performing a visual recognition of the QPU topology configuration, based on the visual recognition, converting the QPU topology configuration into a graph, and, using the graph to generate a mock quantum emulator that is configured and operable to accept a quantum circuit, and perform a mapping process that comprises generating qubit assignments for elements of the quantum circuit.

### COPYRIGHT AND MASK WORK NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyrights whatsoever.

### TECHNOLOGICAL FIELD OF THE DISCLOSURE

Embodiments disclosed herein generally relate to quantum computing. More particularly, at least some embodiments relate to systems, hardware, software, computer-readable media, and methods, for quantum circuit emulation.

### BACKGROUND

Quantum circuit simulators typically emulate a QPU (quantum processing unit) with all-to-all connectivity, that is, in a graph emulating the QPU, all nodes, which may represent respective qubits, are connected to all other nodes. This approach makes the minor-embedding step of transpilation trivial, as every logical qubit represented in the graph only requires a single “physical” qubit. However, this means that there is no way to evaluate the difficulty of minor-embedding on QPU topologies that are not realized in real hardware. Moreover, even if the topology were implemented in real hardware, the transpilation step cannot be completed without hiring and using the hardware, thus potentially costing the developer extra money.

This functionality may be important for various reasons. For example, a quantum algorithm developer may wish to predict, from a compiled circuit, how many logical qubits the developer can implement using a given hardware topology. As well, QPU vendors may wish to optimally develop hardware by choosing the best-performing topology for the purposes of minor-embedding. That is, a vendor may wish to determine which topology(ies) best support common kinds of circuits with minimal SWAP gates and/or lowest physical-logical qubit ratios.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIG. 1 discloses aspects of a first QPU topology.

FIG. 2 discloses aspects of a second QPU topology.

FIG. 3 discloses an example of qubit mapping.

FIG. 4 discloses an example qubit mapping using qubit chains.

FIG. 5 discloses a workflow according to one example embodiment.

FIG. 6 discloses a qubit error rate.

FIG. 7 discloses a coupler, or edge, error rate.

FIG. 8 discloses an example computing entity configured and operable to perform any of the disclosed methods, processes, and operations.

### DETAILED DESCRIPTION OF SOME EXAMPLE EMBODIMENTS

Embodiments disclosed herein generally relate to quantum computing. More particularly, at least some embodiments relate to systems, hardware, software, computer-readable media, and methods, for quantum circuit emulation.

One or more embodiments may comprise software-defined mock QPU topologies, and a method for generating mock QPU topologies. One example of such a method may be implemented using a computing system having a user interface (UI) by way of which a user may input, such as by hand drawing with a stylus for example, a desired QPU topology. In one embodiment, the method comprises: receiving a topology configuration specified by a user; performing a visual recognition of the topology configuration; based on the visual recognition, converting the topology configuration into a graph; and, using the graph to generate an object that is configured to accept a circuit, and generate qubit assignments for elements of the circuit.

It is noted that while reference may be made herein to a “hand drawn” QPU topology generated by a user, the scope of this disclosure is not limited to this example approach. In some embodiments, a user may define a QPU topology in any other suitable manner and other UIs. For example, a user may define a QPU topology using a CLI (command line interface), or voice commands. In still other embodiments, a user may define a QPU topology using a programmatic approach that employs approaches such as executable code, or algorithms.

It is noted further that reference may be made herein to a ‘raw’ topology configuration received from a user, where ‘raw’ refers to the notion that the user has provided only an approximation, or rough draft, which may or may not be in digital form, of a topology configuration before that raw topology configuration has been processed according to a method of one embodiment. As disclosed herein, a hand drawn topology configuration is one non-limiting example of a raw topology configuration, or a topology configuration that is in raw form.

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of one embodiment is that an embodiment may enable a user to avoid the use of actual quantum hardware when experimenting with various graph structures and evaluating how QPUs with those structures would perform transpilation on specified circuits. An embodiment may enable determination of an optimal transpilation for a circuit. An embodiment may enable accumulation of qubit mapping data through random generation of graphs. Various other aspects of one or more example embodiments will be apparent from this disclosure.

### A. Aspects of one Context for an Example Embodiment

The following is a discussion of aspects of a context for various example embodiments. This discussion is not intended to limit the scope of the claims or this disclosure, or the applicability of the embodiments, in any way.

### A.1 Introduction

Many kinds of quantum computers operate on what is referred to as a gate-model. In this model, quantum gates are applied to the analog of bits, that is ‘qubits,’ which can exist in a linear combination of 1 and 0 simultaneously. A quantum circuit is a series of these gates, which when taken together achieve some kind of computation. Upon finishing the circuit, the qubits are typically measured, which involves collapsing the qubits into a definite state of either 1 or 0.

One other important feature of gated QPUs, or simply “QPUs,” is entanglement, that is, briefly, the ability to make the stochastic collapse of a qubit 1 or 0 fail to be independent from the collapse of other qubits. In other words, and by way of illustration and not limitation, it is possible to put 2 qubits into an entangled state whereupon collapsing both, the two qubits will either both be 1 or both be 0, each with 50% chance. While the outcome of each qubit taken individually is now totally random, the distribution of results from the circuit is not random—00 and 11 each have a 50% probability of occurring, while 10 and 01 have a 0% probability of occurring, so there is not a uniform distribution.

### A.2 QPU Topology

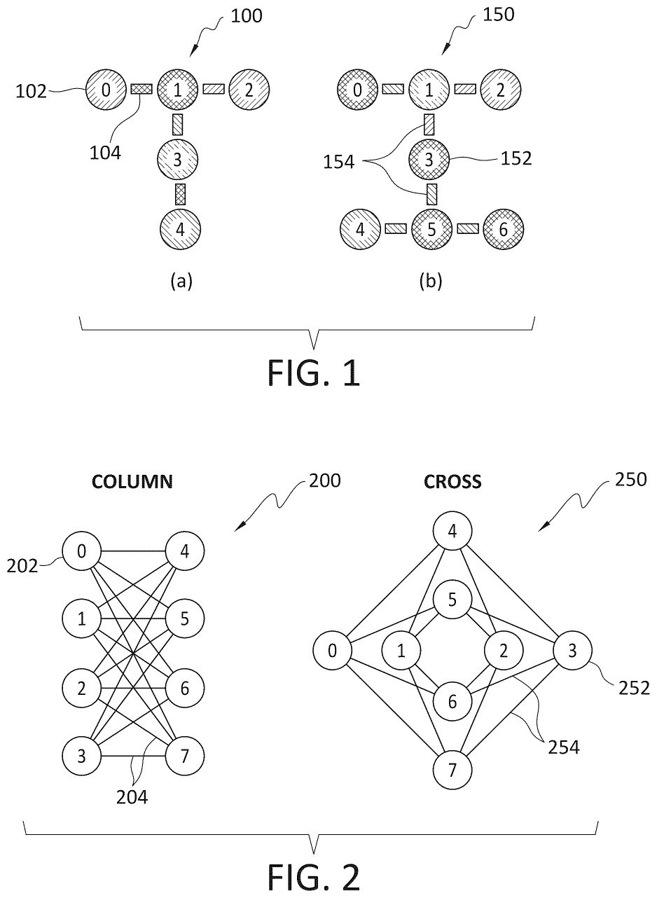

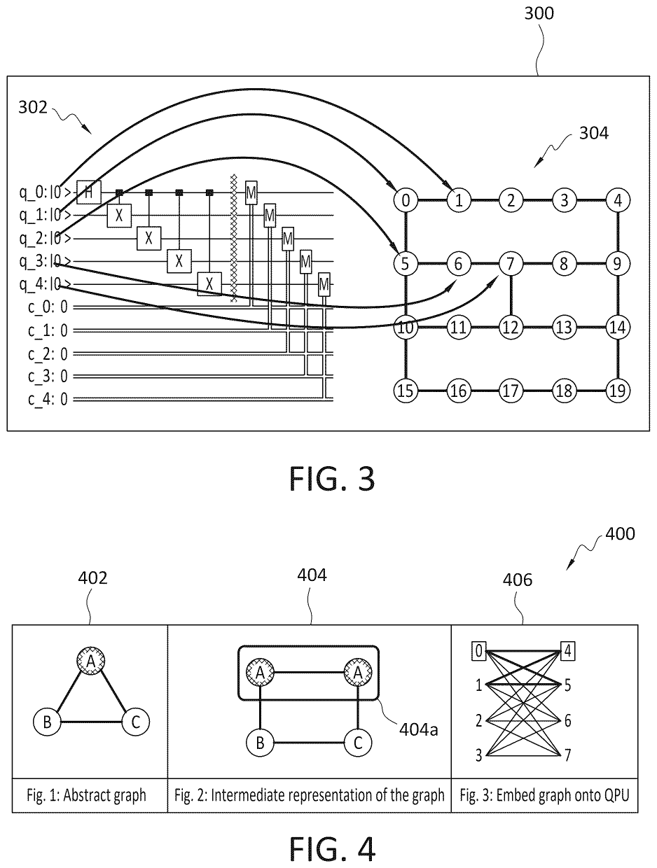

In a QPU with many qubits, it is typically desirable to entangle any two qubits at will, thus allowing for the greatest flexibility when executing circuits that may be expressed as a logical sequence of 1 or 2 qubit gates. However, modern hardware limitations often prevent this full connectivity, especially in the largest scale modalities. Thus, quantum hardware manufacturers must make decisions about which qubits to enable entanglement between. A graphical structure referred to as the QPU topology may be used to visually illustrate qubits and their relation to each other. Examples of some QPU topologies are shown in FIG. 1 and FIG. 2.

Particularly, FIG. 1(a) discloses a QPU topology, or graph, 100 that includes a total of five qubits 102 each indicated by a respective node. A qubit 102 may be connected, in the QPU topology 100, to one or more other qubits 102 by one or more couplers 104. Similarly, FIG. 1(b) discloses a QPU topology 150 having a total of seven qubits 152, each indicated by a respective node, and each connected to one or more other qubits 152 by one or more couplers 154.

FIG. 2 shows two additional examples of QPU topologies 200 and 250. As in the examples of FIG. 1, the QPU topologies 200 and 250 respectively include, one or more qubits 202, couplers 204, qubits 252, and couplers 254. As seen in FIG. 2, QPU topologies may take various general forms such as, but not limited to, a column in the case of the QPU topology 200, or a cross as in the case of the QPU topology 250. The form of a QPU topology may be a function, for example, of the number of qubits, and their relationship(s) with each other.

### A.3 Qubit Mapping

Thus, when a logical qubit included by a developer in circuit design is entangled to another logical qubit, the correspondence with physical qubits, that is, those qubits on a QPU, must be designed so that those two physical qubits can be entangled. This entanglement may be shown in a QPU topology as a vertex that connects the two physical qubits. This qubit mapping is part of a process known as transpilation, which may also include other operations such as, for example, breaking down 3+ qubit gates into 1-qubit and 2-qubit gates.

With reference briefly to FIG. 3, there is shown an example map 300 that maps qubit gates of a circuit to nodes of a QPU topology. For example, q_0 of the circuit 302 is mapped to node 1 of the QPU topology 304. Note that in the map 300, not every node is connected to every other node. Further, some nodes are connected to more nodes than others. For example, node 12 is connected to nodes 7, 11, and 13, a total of three nodes, while node 19 is only connected to nodes 18 and 14, a total of two nodes.

### A.4 Chains

Given the example QPU topologies of FIGS. 1 and 2, and the map 300, suppose that a developer has three physical qubits that all should be entangled with each other. It can be seen in those examples, however, that none have a triangle, that is, three vertices that are all pair-wise connected. In fact, this is an actual restriction on QPUs that commonly occurs in practice. In order to solve this problem, the transpiler sometimes represents one logical qubit with two or more physical qubits. This process is called creating a chain of qubits, that is, the two or more physical qubits are represented in a QPU topology as being connected together.

FIG. 4 discloses an example of a chaining process 400. At 402, a QPU topology is shown that includes three nodes. At 404, the logical ‘A’ node is shown as being represented by a chain 404A of qubits. After the chaining at 404, the graph is then embedded at 406 onto a QPU.

It will be appreciated that having large chains may not be optimal for getting the most out of a QPU, and transpilers will always work to minimize the size of chains, for capacity and noise reasons for example. However, the use of relatively large chains is often an unavoidable and necessary part of the qubit-mapping stage. It should be noted that different QPUs, even with similar qubit counts, can have radically different topologies, based on their modality, examples od which include neutral atom, superconducting, and photonic. Additionally, some topologies are better suited for some kinds of circuits than others, which may mean that some topologies are better at solving some kinds of underlying problems than others.

### B. Detailed Discussion of One Example Embodiment

One example embodiments comprises a method and application that enables a user to specify, such as by manually drawing, a desired QPU topology. That QPU topology may then be used as a basis to generate a mock quantum emulator that is able to perform transpilation, that is, mapping of hardware, namely, quantum circuit elements, to qubits of the user-specified QPU topology.

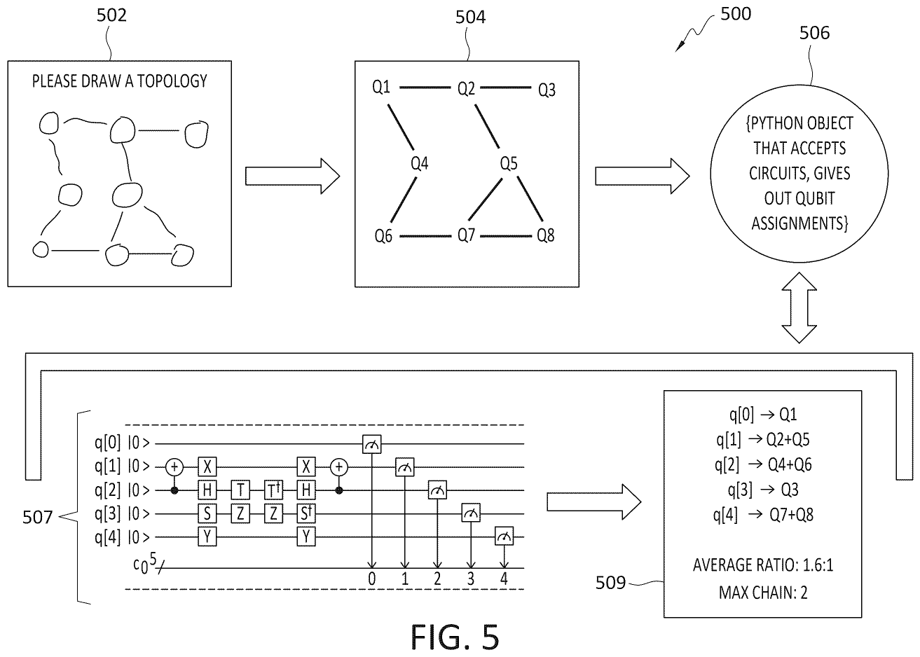

FIG. 5 discloses an example method 500 according to one embodiment. Initially, a user may be prompted 502, such as by way of a UI associated with a computing system for example, to draw a QPU topology desired by the user. The user may provide input by way of the UI, in response to the prompt 502, using a stylus, keyboard, mouse, and/or any other suitable input device.

After the user has created the QPU topology, such as by drawing, the QPU topology may be received and processed by the computing system. Such processing may include, for example, performing a recognition process on the hand drawn picture and using an outcome of the recognition process to generate 504 the requested QPU topology, or graph, that is, the mock QPU. In one embodiment, the recognition of the hand drawn picture, and generation of the graph based on the recognition process, may be performed using, for example, a multi-modal generative Al model. Alternatively, an interface could be presented, to a user, to build a topology using pre-set graphics elements such as vertex and edge, similar to a Miro board (https://miro.com/). This approach would not require any heavy computing effort on the part of the application to recreate the connectivity of the mock QPU.

The graph may, in one embodiment, may be encoded as a purely combinatorial object, as disclosed in https://en.wikipedia.org/wiki/Adjacency_matrix, which is incorporated herein in its entirety by this reference. Using the graph, an object may be generated 506. In one embodiment, this object may be a Python object, although that is not necessarily required. In one embodiment, the object may be referred to as a QMap.

In any case, the object generated at 506 may have a variety of features and capabilities. For example, given a quantum circuit 507 as input, the object may stop at the transpilation step, rather than actually performing a quantum simulation, and will return a proposed qubit mapping 509 for the quantum circuit 507.

### C. Additional Functionalities of One Embodiment

Additionally, the QMap may, in one embodiment, return, for any given circuit, data about the proposed transpilation. Of particular interest may be the ratio of physical qubits to logical qubits where, for example, the ratio may be greater than or equal to 1, and a higher ratio is worse than a relatively lower ratio. As another example, the data returned by the QMap may comprise the maximal chain length, that is, the highest number of physical qubits assigned to any logical qubit. Because these are target metrics used to optimize QPU topology development, they may enable a user to determine what configurations are more desirable than others.

As another example of a QMap functionality, a QMap in one embodiment may have the ability to randomly generate many topologies, and test those topologies in an automated fashion. Then for each topology, the QMap may run a battery of pre-defined circuits, and report an aggregate score such as, for example, average ratio, and average max-chain-length. In one embodiment, these randomly generated topologies may have a fixed number of qubits, and either an average adjacency value, that is, each vertex is connected to k other vertices, on average, or a fixed number of couplers, that is, a total number of edges connecting nodes.

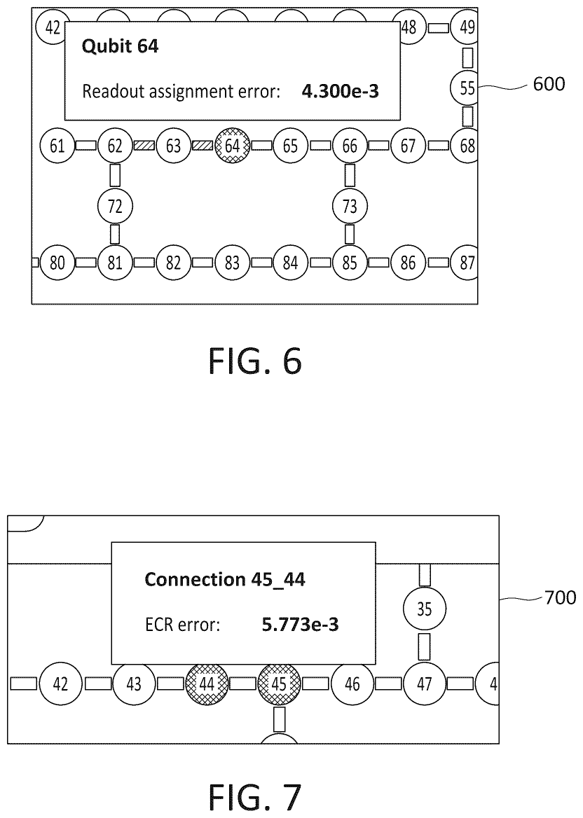

Finally, and with reference to the examples of FIG. 6 and FIG. 7, an embodiment may assign, in a QPU topology, fidelity information to each vertex (1 qubit gate fidelity) and each edge (2 qubit gate fidelity). Based on this mock information, the QMap object can choose qubit assignments that not only fit on the mock QPU but also minimize error, such as the readout assignment error 600 disclosed in FIG. 6. For example, avoiding use of the worst performing qubits if possible, and choosing to assign highly entangled logical qubits to physical qubits that share the lowest error coupler. As to the latter, FIG. 7 discloses an example readout of coupler error rate 700.

### D. Further Discussion

As disclosed herein, one or more embodiments may possess various useful features and aspects, although no embodiment is required to possess any of such features or aspects. The following examples are illustrative, but not exhaustive. One embodiment may comprise a software-defined solution that is able to mock a QPU topology that enables a user to experiment with different graph structures and how QPUs with those structures would perform transpilation on given circuits. An embodiment may comprise a method for randomly generating graphs of fixed qubit count and coupler ratio or count, together with a battery of circuits to transpile using them to accumulate qubit mapping data. As a final example, an embodiment may comprise a method that employs mock error data to provide optimal transpilation given this information, for the purpose of simulating real quantum noise that informs the mapping. As noted herein, noisy simulators exist, but the noise model does not inform transpilation.

By way of comparison with one or more embodiments, some conventional approaches, one of which is implemented by IonQ (https://ionq.com/), may enable users to emulate given real QPUs. However, in this particular example, trapped-ion technology allows for all-to-all connection, making the qubit mapping step of transpilation trivial. This emulation is meant to be used for error prediction, as the emulator adds in simulated noise similar to the noise profile of the quantum computer. As presently understood however, this approach does not provide a quantum emulation solution that enables users to predict qubit mapping patterns.

### E. Example Methods

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

### F. Further Example Embodiments

Following are some further example embodiments. These are presented only by way of example and are not intended to limit the scope of this disclosure or the claims in any way.

Embodiment 1. A method for generating a mock QPU topology, comprising: receiving, from a user, a QPU (quantum processing unit) topology configuration in raw form; performing a visual recognition of the QPU topology configuration; based on the visual recognition, converting the QPU topology configuration into a graph; and, using the graph to generate a mock quantum emulator that is configured and operable to accept a quantum circuit, and perform a mapping process that comprises generating qubit assignments for elements of the quantum circuit.

Embodiment 2. The method as recited in any preceding embodiment, wherein the mock quantum emulator is used to accept a quantum circuit, and performs a transpilation process that comprises generating qubit assignments for elements of the quantum circuit.

Embodiment 3. The method as recited in embodiment 2, wherein the mock quantum emulator stops operating at a conclusion of the transpilation process and does not perform a quantum simulation.

Embodiment 4. The method as recited in any preceding embodiment, wherein the raw form comprises a hand-rendered form.

Embodiment 5. The method as recited in any preceding embodiment, wherein an ML (machine learning) model is used to perform the visual recognition of the QPU topology configuration.

Embodiment 6. The method as recited in any preceding embodiment, wherein the graph comprises nodes that each logically correspond to a respective qubit of a QPU, and the graph comprises edges that each correspond to a coupler that logically couples two of the nodes together.

Embodiment 7. The method as recited in any preceding embodiment, wherein the mock quantum emulator enables the user to generate multiple different graph structures and to determine how QPUs with those respective graph structures may be expected to perform transpilation on particular quantum circuits.

Embodiment 8. The method as recited in any preceding embodiment, wherein the mock quantum emulator enables the user to randomly generate multiple different graphs of fixed qubit count and coupler ratio, and to generate and accumulate qubit mapping data.

Embodiment 9. The method as recited in any preceding embodiment, wherein the mock quantum emulator is configured and operable to use mock error data to provide optimal transpilation, so as to simulate real quantum noise that may be used to guide performance of the mapping process.

Embodiment 10. The method as recited in any preceding embodiment, wherein the mock quantum emulator comprises an executable object.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### G. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

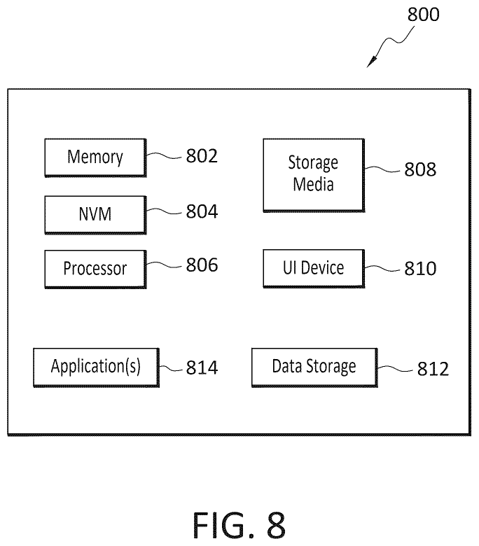

With reference briefly now to FIG. 8, any one or more of the entities disclosed, or implied, by FIGS. 1-7, and/or elsewhere herein, may take the form of, or include, or be implemented on, or hosted by, a physical computing device, one example of which is denoted at 800. As well, where any of the aforementioned elements comprise or consist of a virtual machine (VM), that VM may constitute a virtualization of any combination of the physical components disclosed in FIG. 8.

In the example of FIG. 8, the physical computing device 800 includes a memory 802 which may include one, some, or all, of random access memory (RAM), non-volatile memory (NVM) 804 such as NVRAM for example, read-only memory (ROM), and persistent memory, one or more hardware processors 806, non-transitory storage media 808, UI device 810, and data storage 812. One or more of the memory components 802 of the physical computing device 800 may take the form of solid state device (SSD) storage. As well, one or more applications 814 may be provided that comprise instructions executable by one or more hardware processors 806 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The described embodiments are to be considered in all respects only as illustrative and not restrictive. All changes which come within the meaning and range of equivalency of the claims are to be embraced within their scope.

What is claimed is:

1. A method for generating a mock QPU topology, comprising:
receiving, from a user, a QPU (quantum processing unit) topology configuration in raw form;
performing a visual recognition of the QPU topology configuration;
based on the visual recognition, converting the QPU topology configuration into a graph; and,
using the graph to generate a mock quantum emulator that is configured and operable to accept a quantum circuit, and perform a mapping process that comprises generating qubit assignments for elements of the quantum circuit.

2. The method as recited in claim 1, wherein the mock quantum emulator is used to accept a quantum circuit, and performs a transpilation process that comprises generating qubit assignments for elements of the quantum circuit.

3. The method as recited in claim 2, wherein the mock quantum emulator stops operating at a conclusion of the transpilation process and does not perform a quantum simulation.

4. The method as recited in claim 1, wherein the raw form comprises a hand-rendered form.

5. The method as recited in claim 1, wherein an ML (machine learning) model is used to perform the visual recognition of the QPU topology configuration.

6. The method as recited in claim 1, wherein the graph comprises nodes that each logically correspond to a respective qubit of a QPU, and the graph comprises edges that each correspond to a coupler that logically couples two of the nodes together.

7. The method as recited in claim 1, wherein the mock quantum emulator enables the user to generate multiple different graph structures and to determine how QPUs with those respective graph structures may be expected to perform transpilation on particular quantum circuits.

8. The method as recited in claim 1, wherein the mock quantum emulator enables the user to randomly generate multiple different graphs of fixed qubit count and coupler ratio, and to generate and accumulate qubit mapping data.

9. The method as recited in claim 1, wherein the mock quantum emulator is configured and operable to use mock error data to provide optimal transpilation, so as to simulate real quantum noise that may be used to guide performance of the mapping process.

10. The method as recited in claim 1, wherein the mock quantum emulator comprises an executable object.

11. A non-transitory storage medium having stored therein instructions that are executable by one or more hardware processors to perform operations comprising:
receiving, from a user, a QPU (quantum processing unit) topology configuration in raw form;
performing a visual recognition of the QPU topology configuration;
based on the visual recognition, converting the QPU topology configuration into a graph; and,
using the graph to generate a mock quantum emulator that is configured and operable to accept a quantum circuit, and perform a mapping process that comprises generating qubit assignments for elements of the quantum circuit.

12. The non-transitory storage medium as recited in claim 11, wherein the mock quantum emulator is used to accept a quantum circuit, and performs a transpilation process that comprises generating qubit assignments for elements of the quantum circuit.

13. The non-transitory storage medium as recited in claim 12, wherein the mock quantum emulator stops operating at a conclusion of the transpilation process and does not perform a quantum simulation.

14. The non-transitory storage medium as recited in claim 11, wherein the raw form comprises a hand-rendered form.

15. The non-transitory storage medium as recited in claim 11, wherein an ML (machine learning) model is used to perform the visual recognition of the QPU topology configuration.

16. The non-transitory storage medium as recited in claim 11, wherein the graph comprises nodes that each logically correspond to a respective qubit of a QPU, and the graph comprises edges that each correspond to a coupler that logically couples two of the nodes together.

17. The non-transitory storage medium as recited in claim 11, wherein the mock quantum emulator enables the user to generate multiple different graph structures and to determine how QPUs with those respective graph structures may be expected to perform transpilation on particular quantum circuits.

18. The non-transitory storage medium as recited in claim 11, wherein the mock quantum emulator enables the user to randomly generate multiple different graphs of fixed qubit count and coupler ratio, and to generate and accumulate qubit mapping data.

19. The non-transitory storage medium as recited in claim 11, wherein the mock quantum emulator is configured and operable to use mock error data to provide optimal transpilation, so as to simulate real quantum noise that may be used to guide performance of the mapping process.

20. The non-transitory storage medium as recited in claim 11, wherein the mock quantum emulator comprises an executable object.
